(19) United States
(12) Patent Application Publication
(10) Pub. No.: US 2024/0284839 A1
(43) Pub. Date: Aug. 29, 2024

(54) GROW MAT

(71) Applicant: Greenspaces, LLC dba Urban Greens, Iowa City, IA (US)

(72) Inventors: Theodore Robert Myers, Iowa City, IA (US); Chad Michael Treloar, Iowa City, IA (US)

(21) Appl. No.: 18/585,255

(22) Filed: Feb. 23, 2024

Related U.S. Application Data
(60) Provisional application No. 63/448,123, filed on Feb. 24, 2023.

(51) Int. Cl. A01G 24/46; A01G 24/30; B32B 5/02; B32B 5/26; B32B 7/023

(52) U.S. Cl. CPC A01G 24/46; A01G 24/30; B32B 5/022; B32B 5/266; B32B 7/023; B32B 2250/02; B32B 2250/20; B32B 2255/02; B32B 2262/0253; B32B 2262/0284; B32B 2307/4026; B32B 2307/726; B32B 2307/7376; B32B 2410/00

(57) ABSTRACT

The present invention is a growth medium including a mat having at least a first layer and a second layer of synthetic material connected together, where the first layer differs from the second layer in at least one of the following characteristics: color, porosity, composition material, coating material, material construction, thickness, water retentiveness, or presence of water channels. The invention also relates to methods of cultivating plants using the described growth media.

### CLAIM OF PRIORITY

This application claims the benefit of U.S. provisional application No. 63/448,123, filed on Feb. 24, 2023, which is incorporated by reference in its entirety.

### FIELD OF THE INVENTION

The present invention relates to improved grow mats used for indoor or greenhouse cultivation of plant material.

### BACKGROUND OF THE INVENTION

Traditional agriculture crops are grown in soil. Soil provides both physical stability to the growing plant, as well as the environment that allows for the plant roots to uptake nutrients required for healthy growth. Many indoor plant cultivation strategies such as hydroponics, aeroponics and aquaponics, do away with soil as a growing medium. The nutrients required for plant growth are dissolved directly into water and applied to the plants by different means defined by each growing system. Some of these systems provide just physical stability to plants by holding the stem, while the roots are allowed to grow in open air or submerged in nutrient water. Others use various forms of inert media such as expanded clay, perlite, or rockwool for plant rooting material. Additionally, various fabrics, screens, and meshes or mats are used as growing mediums in plant cultivation.

While soil cultivation has been the standard growing medium for plants on earth for all of human history, when it comes to indoor cultivation, soil (including peat) is not the ideal medium. It may be a non-renewable natural resource and it can be expensive. Many systems that utilize recirculating nutrient watering run the risk of dissolved and undissolved soil matter being carried throughout the system. This can result in damage to pumps, filters and other equipment, as well as increasing the risk of pathogen contamination throughout the system. Soil mixes can also foster insect pests that do damage to growing plants and roots that are virtually impossible to remove from the facility without potentially toxic pesticide treatments. Also, soil can only be used for a single planting and it requires an extensive aging and composting procedure before it can be ready to be replanted.

None of the other known growth media adequately satisfy all of the competing characteristics desired in a growth medium. For example, some inadequate soilless loose material media include coco coir (made from coconut fibers), perlite (comprised of volcanic glass), or leca (lightweight expanded clay aggregate). Some inadequate mats include natural fiber mats of hemp, burlap, or biostrate, or mineral fiber mats such as rockwool.

None of these are sufficient for a high yield, high efficiency indoor plant cultivation system. Desirable grow media should be chemically inert and not effect nutrient water chemistry. The media must be food safe material that does not degrade, rot, or break down in wet conditions. The media have high surface area and porosity allows for adequate water retention along with some structural integrity that creates aerobic zones for root and nutrient solution uptake. Also, the media should not be so dense that it impedes root growth, while also providing structural stability for growing plants. The media must also allow for a high rate of seed germination.

### SUMMARY OF THE INVENTION

The present invention relates to growth media for indoor or greenhouse cultivation of plants in the form of a multilayer grow mat. The grow mat is generally planar in format such that the length and width are larger than the thickness so as to provide sufficient area to efficiently grow plants. The grow mat comprises at least two layers of synthetic materials. The first layer is the grow layer and the second layer is the base layer, where the first and second layers are different from each other in at least one characteristic. The first layer is preferably adapted to encourage germination rates for plants being grown, while the second layer is preferably adapted to retain water and provide physical stability for plant roots. The first and second layers are attached together to form a unitary mat, preferably by stitching. The mats may include grommets to facilitate vertical hanging of the mats. The invention relates to methods of cultivating plants using the described growth media.

### BRIEF DESCRIPTION OF THE DRAWINGS

FIG. 1 shows an oblique view of a grow mat.

FIG. 2 shows a side view of a grow mat.

### DETAILED DESCRIPTION

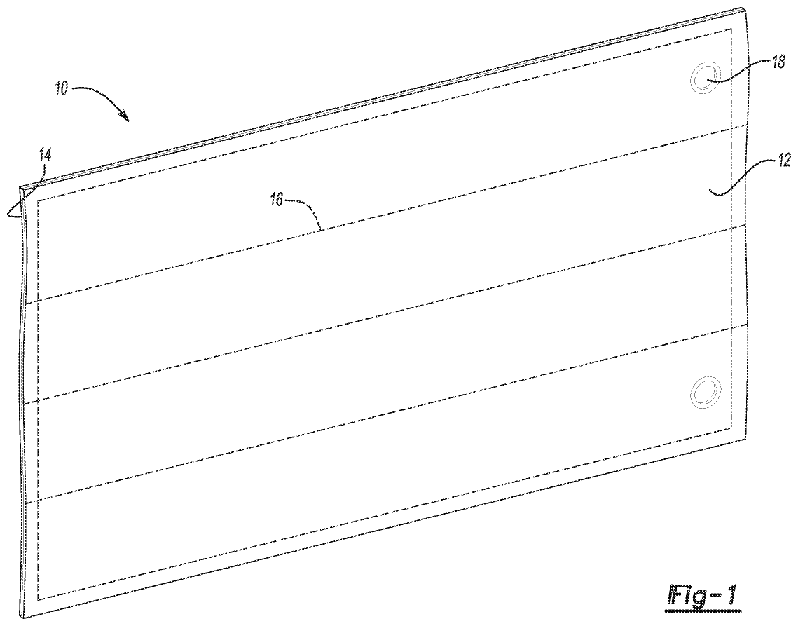

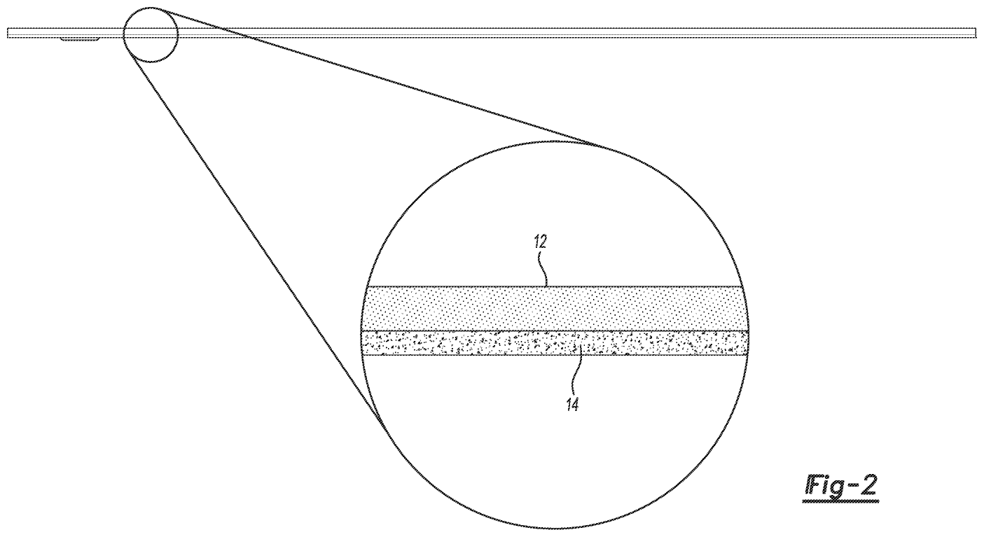

As seen in FIGS. 1 and 2, the growth media of the present invention is a multilayer grow mat 10 having at least two layers 12, 14 of synthetic materials, wherein at least one characteristic of each of the at least two layers differ from the other. The first layer is generally on the top and faces the light source while the second layer is generally on the bottom and faces away from the light source, although these orientations are relative, because, depending on the type of plant being cultivated, the second layer may face the light source and the first layer may face away from the light source. The first layer is sometimes referred to as the grow layer, and the second layer is sometimes referred to as the base layer.

The grow mat generally has a planar format such that it has a surface area upon which plants can be cultivated and the thickness of the mat is minimal compared to the cultivation area of the mat, as seen in FIG. 1. The size and shape of the surface area of the mat is not particularly critical, although it is preferable for the mat to be sized and shaped to match standard size grow trays, gutters, troughs, basins, channels, or any other container.

The layers of the mat are connected to each other (at reference numeral 16) to form a unitary construction. While adhesives may be used, stitching or welding (e.g. heat tacking or ultrasonic welding) is more preferred, as the adhesive may break down over time, reducing the useful life of the mat and otherwise introducing undesirable materials into the growing system. Connection through stitching or welding is cost effective while insuring a long useful life and no introduction of contaminants. A specific pattern of stitching or welding is not required although a perimeter connection along with one or more interior connections are desirable. See FIG. 1, which shows a perimeter connection 2 interior connections made with stitching. The stitching or welding may form a continuous or intermittent connection between the layers, such as a continuous line, an intermittent line, or a pattern of tacks between the layers, etc.

The overall thickness of the grow mat is dependent on the type of plant being cultivated, and should be selected to ensure that the mat provides the necessary physical stability to allow the roots to hold the plant upright and to otherwise have the water retention characteristics necessary for that particular plant. On the other hand, the grow mat should not be so thick that the mat does not have the desired water retention or other characteristics that interfere with plant cultivation or operation of the grow facility. For example, the mat may be too thin and thus not be durable. Or the mat maybe too thick and thus be too heavy to efficiently harvest plants. In general, the grow mat will be at least 1 cm thick and less than 3 cm thick.

The characteristics of the synthetic layers that may be selected to differ from each other include color, porosity (or density), composition material, coating material, material construction, thickness, water retentiveness, presence of water channels, etc.

The color of the first layer or light source facing layer is preferred to maximize reflection of light (visible or otherwise) back toward the stem and leaves of the plant. A white color is most preferred, although other pale colors may also be used. Also, metallic or mirror materials may be used in the layer to increase the reflectiveness of the first layer. The color of the second layer or the reverse of the light facing layer is preferred to maximize absorption of light (visible or otherwise), so as to provide a darker environment for the roots of the plant being cultivated. Black or earth-tones are preferred for the second layer.

The porosity of the first layer is preferred to be higher compared to the second layer; that is, more empty space between the material of the first layer compared to the second layer. With higher porosity (and thus lower density) of the layer, the seeds can be lodged in the first layer rather than the second layer. This facilitates seed germination at a location that then allows for the roots to grow into the denser second layer. The denser second layer may also facilitate a greater ability to retain water compared to the first layer.

The composition of the material that makes up the layers may be any synthetic material such as polyester, polypropylene, ethylene polyester (PET), poly-1, 4-cyclohexylene terephthalate polyester (PCDT), or combinations thereof. The composition of the material may be selected to provide the differing characteristics of the layers. For example, one type of polyester may have higher water retentive characteristics compared to another type of polyester or another type of synthetic material. In addition, one layer may include an add-in of a differing material so as to create the differing characteristic between the layers. For example, a metallic filament may be incorporated into one layer to increase the light reflectiveness of that layer compared to the other layer.

The materials of each layer may be coated at the molecular level to provide differing characteristic between the layers. For example, an anti-fungal or anti-bacterial coating may be used on the material of the second layer to reduce the instance of root rot or slimy roots. A reflective coating may be used on some or all of the material in the first layer to improve the overall reflectiveness of the layer. A hydrophobic coating may be used on the first layer as a way of reducing water retentiveness of that layer. In addition, coating that release nutrients over time may be utilized.

The material construction of each layer may be selected from woven and non-woven fabrics, with non-woven fabric preferred due to their wide array of available thicknesses, water retentiveness characteristics, and low cost. Preferred non-woven fabric include felted or bonded fabrics, with needle-punched fabrics preferred for the first layer due the lower density and higher porosity. Tufted fabrics (resulting from use of a tuft gun) may be preferred for the second layer as these tend to be denser.

The thickness of the first layer is generally thinner than the second layer, but is not required to be so. The thicker second layer generally provides the mat, and the growing plants, with greater stability to maintain the stems and leaves in position for continued growth of the plant.

The water retentiveness of the first layer is generally lower than that of the second layer. Lower water content (but still sufficient for germination) in the first layer will improve germination rates of seeds. On the other hand, higher water retentiveness in the second layer guards against the roots (and plants) from accidentally drying out.

Each of the layers may include water channels to increase or decrease the speed at which water flows through or around the mat. For example, the second layer may include ridges on surface adjacent to the tray or container in which the mat sits. This could raise portions of the mat from the tray to create water channels. Such channels may be parallel, oblique, perpendicular, (or any combination) to the water flow, as a way of increasing or decreasing the water flow or water flow rate through the container. Similarly, the surfaces of the layers facing each other may each or both have ridges to create water channels. In addition, tunnels or tubes through a layer may also be utilized to increase or decrease water flow or water flow rate.

The grow mats may include additional layers. For example, screen or mesh may be used between the first and second layer or under the second layer to increase rigidity of the mat. Such screens or mesh should have porosity that is high enough to not interfere with plant growth. The mats may include additional components that facilitate seeding, germinating, growing, or harvesting plants, or the reconditions of mats after use. For example, grommets 18 may be used to facilitate holding the mats in the container or for hanging mats during cultivation, harvesting, cleaning, etc.

The grow mats of the present invention may be used in any indoor or greenhouse cultivation system and particularly in any system that includes flowing water. In general, water is applied at an inlet end of a growing container and carried by gravity to the outlet or drain end. The water flows both through and beneath the grow mat. Seeds are lodged on or in the grow mat; e.g. in the grow layer of the mat and allowed to germinate. After germination, roots grow throughout the layer(s) of the mat and ultimately through the mat to interface with the nutrient water under the mat. After a relatively short water cycle, the growing environment is kept moist (either through ambient humidity or the water retained in the grow mat) and gives the roots more access to nutrient water that has been absorbed by the mat. When the grow container (and thus grow mats) are kept at an angle (relative to the floor), the water drains from the high point to the low point, which allows for a metered or measured drying period before a next watering cycle is activated. When kept level, the grow mats retain moisture for much longer and when properly covered allows for several days of germination without the need for extra waterings. At the appropriate time, the cultivated plants are harvested. The grow mats are then cleaned to remove root material and otherwise refresh the mats for the next round of cultivation.

The benefits of using the inventive grow mats include reducing the demand for constant watering, simplifying the equipment necessary to contain and support growing plants in the system, allowing for high density plantings without a similar increase to grow media usage, improving moisture retention prevents plant damage from drying roots, easing harvest, etc.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. Plural structural components or steps can be provided by a single integrated structure or step. Alternatively, a single integrated structure or step might be divided into separate plural components or steps. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

What is claimed is:

1. A growth medium, comprising a mat having at least a first layer and a second layer of synthetic material connected together, wherein the first layer differs from the second layer in at least one of the following characteristics: color, porosity, composition material, coating material, material construction, thickness, water retentiveness, or presence of water channels.

2. The mat of claim 1 wherein the first layer is lighter in color than the second layer.

3. The mat of claim 1 wherein the first layer is more porous than the second layer.

4. The mat of claim 1 wherein the composition of the first layer is different from the composition of the second layer.

5. The mat of claim 1 wherein the first layer comprises a coating and the second layer comprises no coating or a different coating from that of the first layer.

6. The mat of claim 1 wherein the first layer comprises a needle punched material and the second layer does not.

7. The mat of claim 1 wherein the second layer comprises a tufted material and the first layer does not.

8. The mat of claim 1 wherein the thickness of the first layer is different from the thickness of the second layer.

9. The mat of claim 1 wherein the water retentiveness of the first layer is different from the water retentiveness of the second layer.

10. The mat of claim 1 wherein the layers are connected together at or near the perimeter of the mat.

11. The mat of claim 1 wherein the first layer differs from the second layer in at least two of the following characteristics: color, porosity, composition material, coating material, material construction, thickness, water retentiveness, or presence of water channels.

12. The mat of claim 11 wherein the first layer differs from the second layer in color and water retentiveness.

13. The mat of claim 11 wherein the first layer differs from the second layer in composition material and thickness.

14. The mat of claim 11 wherein the first layer differs from the second layer in composition material and thickness.

15. The mat of claim 11 wherein the first layer differs from the second layer in at least three of the following characteristics: color, porosity, composition material, coating material, material construction, thickness, water retentiveness, or presence of water channels.

16. The mat of claim 15 wherein the first layer differs from the second layer in color, thickness, and water retentiveness.

17. The mat of claim 15 wherein the first layer differs from the second layer in porosity, composition material, and material construction.

18. A method of cultivating plants in an indoor or greenhouse environment, comprising: Placing a plurality of seeds or cuttings on a grow mat having at least a first layer and a second layer of synthetic material connected together, wherein the first layer differs from the second layer in at least one of the following characteristics: color, porosity, composition material, coating material, material construction, thickness, water retentiveness, or presence of water channels.

19. The method of claim 18, wherein the first layer differs from the second layer in at least two of the following characteristics: color, porosity, composition material, coating material, material construction, thickness, water retentiveness, or presence of water channels.

20. The method of claim 18, wherein the first layer differs from the second layer in at least three of the following characteristics: color, porosity, composition material, coating material, material construction, thickness, water retentiveness, or presence of water channels.
